(19) United States
(12) Patent Application Publication
(10) Pub. No.: US 2018/0280795 A1
(43) Pub. Date: Oct. 4, 2018

(54) GAME PROGRAM, GAME TERMINAL DEVICE, AND GAME PROGRESS CONTROL METHOD

(71) Applicant: SQUARE ENIX CO., LTD., Tokyo (JP)

(72) Inventors: Kento YOKOTA, Tokyo (JP); Takeshi UCHIKAWA, Tokyo (JP)

(73) Assignee: SQUARE ENIX CO., LTD., Tokyo (JP)

(21) Appl. No.: 15/919,571

(22) Filed: Mar. 13, 2018

(30) Foreign Application Priority Data
Mar. 30, 2017 (JP) 2017-68597

(51) Int. Cl. A63F 13/34

(52) U.S. Cl. CPC A63F 13/34

(57) ABSTRACT

Provided is a game program causing a portable computer capable of wirelessly communicating with another computer positioned in a communicable range to realize a function of controlling progress of a video game using a first game medium possessed by a user, the game program causing the computer to realize a reception function of receiving information regarding a second game medium from the another computer through wireless communication, and a generation function of generating a third game medium based on the first game medium and the second game medium in accordance with establishment of a generation condition.

### BACKGROUND OF THE INVENTION

### 1. Field of the Invention

At least one embodiment of the present invention relates to a game program causing a portable computer capable of wirelessly communicating with another computer which is positioned in a communicable range to control the progress of a video game using a game medium possessed by a user.

### 2. Description of Related Art

Some video games (games) executed by a portable game device have a communication function (a so-called StreetPass Communication function) of automatically detecting another game device capable of short-range communication to transmit and receive game data such as a character (for example, see Japanese Patent No. 4073885 and Japanese Patent No. 4652190).

### SUMMARY OF THE INVENTION

In a game having the above-described communication function, it is possible to play a game using, for example, received game data. However, only the use of the unchanged game data received is monotonous, and thus there is a concern that a user's interest in the above-described communication function is lost. Therefore, in the game, a task is to make it possible to more effectively utilize the received game data.

An object of at least one embodiment of the present invention is to solve the deficiency of the related art.

From the non-limiting viewpoint, according to an aspect of the present invention, there is provided a game program causing a portable computer capable of wirelessly communicating with another computer positioned in a communicable range to realize a function of controlling progress of a video game using a first game medium possessed by a user, the game program causing the computer to realize a reception function of receiving information regarding a second game medium from the another computer through wireless communication, and a generation function of generating a third game medium based on the first game medium and the second game medium in accordance with establishment of a generation condition.

From the non-limiting viewpoint, according to another aspect of the present invention, there is provided a portable game terminal device which is capable of wirelessly communicating with another game terminal device positioned in a communicable range and realizes a function of controlling progress of a video game using a first game medium possessed by a user, the game terminal device including a receptionist configured to receive information regarding a second game medium from the another game terminal device through wireless communication, and a generator configured to generate a third game medium based on the first game medium and the second game medium in accordance with establishment of a generation condition.

From the non-limiting viewpoint, according to still another aspect of the present invention, there is provided a game progress control method of causing a portable computer capable of wirelessly communicating with another computer positioned in a communicable range to control progress of a video game by using a first game medium possessed by a user, the game progress control method including a reception process of receiving information regarding a second game medium from the another computer through wireless communication, and a generation process of generating a third game medium based on the first game medium and the second game medium in accordance with establishment of a generation condition.

One or two or more deficiencies are solved by embodiments of the present application.

### BRIEF DESCRIPTION OF THE DRAWINGS

FIG. 1 is a block diagram of a configuration of a terminal device showing an example of a configuration of a terminal device corresponding to at least one embodiment of the present invention.

FIG. 2 is a flowchart showing an example of a game progress process executed by the terminal device corresponding to at least one embodiment of the present invention.

FIG. 3 is a block diagram of a configuration of a terminal device showing an example of a configuration of the terminal device corresponding to at least one embodiment of the present invention.

FIG. 4 is a flowchart showing an example of a game progress process executed by the terminal device corresponding to at least one embodiment of the present invention.

FIG. 5 is a block diagram of a configuration of a terminal device showing an example of a configuration of the terminal device corresponding to at least one embodiment of the present invention.

FIG. 6 is a flowchart showing an example of a game progress process executed by the terminal device corresponding to at least one embodiment of the present invention.

FIG. 7 is a block diagram of a configuration of a terminal device showing an example of a configuration of the terminal device corresponding to at least one embodiment of the present invention.

FIG. 8 is a flowchart showing an example of a game progress process executed by the terminal device corresponding to at least one embodiment of the present invention.

FIG. 9 is a diagram showing the exterior of a terminal device which is an example of the terminal device corresponding to at least one embodiment of the present invention.

FIGS. 10A and 10B are diagrams respectively showing examples of a game image displayed on a display unit of the terminal device corresponding to at least one embodiment of the present invention.

FIG. 11 is a diagram showing the generation of a blend party character by the terminal device corresponding to at least one embodiment of the present invention.

FIG. 12 is a diagram showing an example of a plurality of game spaces corresponding to at least one embodiment of the present invention.

FIGS. 13A and 13B are diagrams respectively showing examples of a user data table and a parameter table corresponding to at least one embodiment of the present invention.

FIG. 14 is a diagram showing an example of a reception table corresponding to at least one embodiment of the present invention.

FIGS. 15A and 15B are diagrams respectively showing examples of a stock table and a disposition table corresponding to at least one embodiment of the present invention.

FIGS. 16A and 16B are diagrams respectively showing examples of a first probability table and a bonus table corresponding to at least one embodiment of the present invention.

FIG. 17 is a block diagram showing an example of a configuration of the terminal device corresponding to at least one embodiment of the present invention.

FIG. 18 is a flowchart showing an example of a game progress process executed by the terminal device corresponding to at least one embodiment of the present invention.

### DESCRIPTION OF EMBODIMENTS

Hereinafter, examples of embodiments of the present invention will be described with reference to the drawings. Various constituent elements in the examples of the embodiments described below may be combined with each other as appropriate, unless contradiction or the like occurs therein. The content described in an example of a certain embodiment is not described in other embodiments in some cases. The content of an operation or a process which is not related to a feature portion of each embodiment is omitted in some cases. An order of various processes constituting various flows described below is arbitrary, unless contradiction or the like occurs in the process content.

### First Embodiment

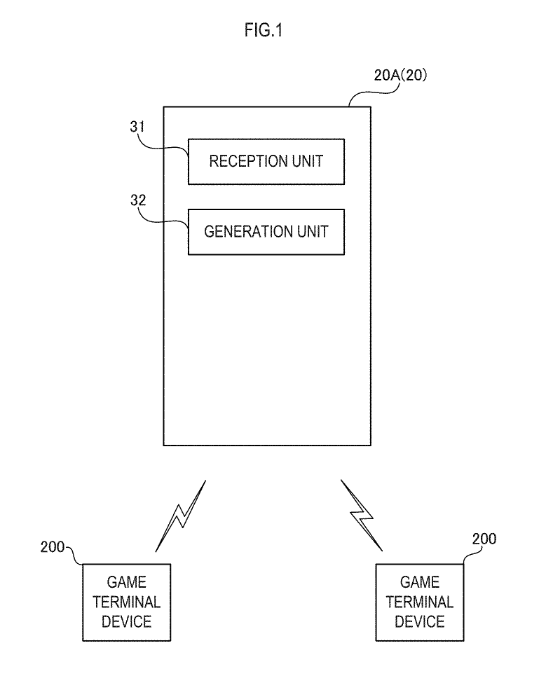

FIG. 1 is a block diagram of a configuration of a terminal device 20A showing an example of a configuration of a terminal device 20 corresponding to at least one embodiment of the present invention. The terminal device (game terminal device) 20 is a portable computer used by a user (player), and can wirelessly communicate with another terminal device 200 positioned in a communicable range.

The terminal device 20 has various functions for executing a video game (game) using a virtual game medium possessed by the user. The game medium is electronic data used for the game and includes, for example, a card, an item, a character, an avatar, and the like. In the game which is an example of this embodiment, a new game medium is generated on the basis of the game medium possessed by the user (player) and a game medium transmitted from the another terminal device 200. The terminal device 20 receives information regarding the game medium through wireless communication from the another terminal device 200 which is positioned in a communicable range.

Hereinafter, the game medium possessed by the user of the terminal device 20 will be referred to as a first game medium, and the game medium transmitted from the another terminal device 200 will be referred to as a second game medium. In addition, a game medium generated on the basis of the first game medium and the second game medium will be referred to as a third game medium. In addition, the possession of the game medium means a state where the user can use the game medium in the game. For example, the possession of the game medium means a state where the game medium is set as a usable game medium in information (user data) regarding the game of the user.

The terminal device 20 is constituted by a portable terminal device, such as a mobile phone terminal, Personal Digital Assistants (PDA), or a portable game device, which is capable of executing a game. Meanwhile, the another terminal device 200 also has the same configuration as that of the terminal device 20, and thus a detailed description thereof will be omitted.

In addition, the terminal device 20 includes an operation unit (a touch panel, an operation controller, or the like) for executing a game, a storage unit such as a hard disk drive, a control unit which is constituted by a CPU or the like executing the game to generate a game image, a display unit that displays the game image, a communication unit that wirelessly communicates with the another terminal device 200, and the like. However, this is a general configuration, and thus a detailed description thereof will be omitted. In the terminal device 20, software (game program) for executing the game and controlling the progress of the game is stored in the storage unit. Meanwhile, the game program also includes game data.

Next, a configuration of a terminal device 20A which is an example of the configuration of the terminal device 20 will be described. The terminal device 20A includes at least a reception unit (reception function) 31 and a generation unit (generation function) 32 which are used when the control unit executes the game program to control the progress of the video game.

The reception unit 31 receives information regarding the second game medium from the another terminal device 200 through wireless communication. The generation unit 32 generates the third game medium based on the first game medium and the second game medium in accordance with the establishment of a generation condition.

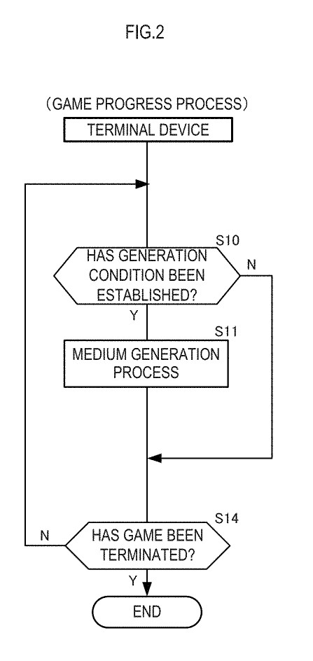

FIG. 2 is a flowchart showing an example of a game progress process which is executed by the terminal device 20A. In the game progress process, a process for progressing the game, such as the generation of the third game medium based on the first game medium and the second game medium, is performed. Meanwhile, in FIG. 2, a process related to the generation of the third game medium is mainly shown, and other game progress processes are not shown.

The execution of the game progress process which is an example of this embodiment is started, for example, with the user's input of an operation of starting the game.

In the game progress process, the terminal device 20A determines whether or not the generation condition has been established (step S10). In a case where the generation condition has not been established (step S10: NO), the terminal device 20A proceeds to the process of step S14. On the other hand, in a case where the generation condition has been established (step S10: YES), the terminal device 20A generates the third game medium based on the first game medium and the second game medium (step S11). Information regarding the generated third game medium may be stored in, for example, a storage unit of the terminal device 20A.

Thereafter, the terminal device 20A determines whether or not the game has been terminated (step S14). For example, the terminal device 20A may determine that the game has been terminated in a case where a predetermined termination condition, such as the game being set to be in a clear state, has been satisfied. In a case where the game has not been terminated (step S14: NO), the terminal device 20A returns to the process of step S10. On the other hand, in a case where the game has been terminated (step S14: YES), the terminal device 20A terminates the game progress process.

As described above, as an aspect of the first embodiment, the terminal device 20A is configured to include the reception unit 31 and the generation unit 32, and thus it is possible to adopt not only a configuration in which the second game medium is received but also a configuration in which the third game medium based on the first game medium and the received second game medium is generated. Therefore, in the game, it is possible to more effectively utilize the received game data (second game medium) and to improve the user's interest in a communication function (wireless communication).

Meanwhile, the above-described information regarding the second game medium corresponds to, for example, parameters of the second game medium. The parameters are data constituting the game medium and include, for example, a rarity indicating the degree of rarity, ability values such as a striking power and vitality (HP), a status indicating the state of the game medium, sex, a name, and the like.

As the above-described wireless communication, a communication system such as Wi-Fi can be applied. However, this is a general configuration, and thus a detailed description thereof will be omitted. In this case, for example, the terminal device 20 and the another terminal device 200 may automatically detect each other by using wireless communication, and may automatically transmit information regarding the second game medium to the detected party. Meanwhile, the terminal device 20 and the another terminal device 200 may transmit and receive the game medium to and from each other.

The above-described generation condition can be arbitrarily set. For example, the elapse of a predetermined period of time from the previous generation of the third game medium, the user's game situation being set to be a predetermined situation, and the like may be the condition. For example, the predetermined situation is a situation where a player object (character) operated by the user moves from the present game space to another game space.

Regarding the above-described third game medium, any configuration may be adopted as long as the configuration is a configuration in which the third game medium is generated using information on either the first game medium or the second game medium. For example, a configuration in which parameters of the third game medium are determined on the basis of at least some of the parameters of the first game medium and at least some of the parameters of the second parameter also corresponds to the generation. More specifically, a configuration in which only the rarity of the third game medium is determined on the basis of the rarity of the first game medium and the rarity of the second game medium also corresponds to the generation.

In addition, after the third game medium is generated, the first game medium and the second game medium used for the generation may not be eliminated. For example, the third game medium is additionally generated, and the states of the first game medium and the second game medium are maintained (do not change) before and after the generation. In this case, the first game medium and the second game medium may be used again for the generation of a new third game medium.

Further, for example, the generated third game medium may be possessed by the user without condition. Alternatively, the user may be able to possess the third game medium in a case where an acquisition condition is satisfied. Examples of the acquisition condition may include a condition in which the third game medium is disposed in a game space and a player object operated by the user moves to the vicinity of the position where the third game medium is disposed. In addition, the third game medium possessed by the user may be set to be a first game medium, and the first game medium may be used for the generation of a new third game medium.

Meanwhile, the first game medium, the second game medium, and the third game medium may be the same type or may be different types.

In addition, the above-described game to be adopted may be a game of any genre such as a role playing game or a growing game as long as the game is configured to have a virtual game medium.

Meanwhile, in the above-described wireless communication, the transmission and reception of data can be performed even while the user is not playing a game, as long as the wireless communication is performed in a state where the communication function of the terminal device 20 is running.

### Second Embodiment

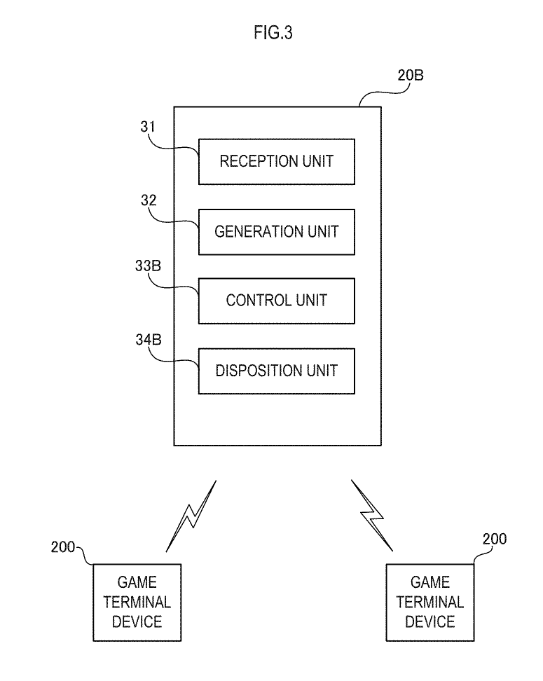

FIG. 3 is a block diagram showing a configuration of a terminal device 20B which is an example of the terminal device 20. In this example, the terminal device 20B includes at least a reception unit 31, a generation unit 32, a control unit (control function) 33B, and a disposition unit (disposition function) 34B.

The reception unit 31 receives information regarding a second game medium from another terminal device 200 through wireless communication. The generation unit 32 generates a third game medium based on a first game medium and the second game medium in accordance with the establishment of a generation condition. The control unit 33B controls the motion of a player object operated by a user in a game space. In addition, the disposition unit 34B disposes the generated third game medium in a game space so that the player object (or the user) can acquire the third game medium.

That is, in the example of this embodiment, the player object (or the user) can acquire the third game medium disposed in the game space. For example, the player object moved to the vicinity of the position where the third game medium is disposed may be caused to execute an acquisition motion. The acquired third game medium is possessed by the user.

Next, the operation of the terminal device 20B which is an example of this embodiment will be described.

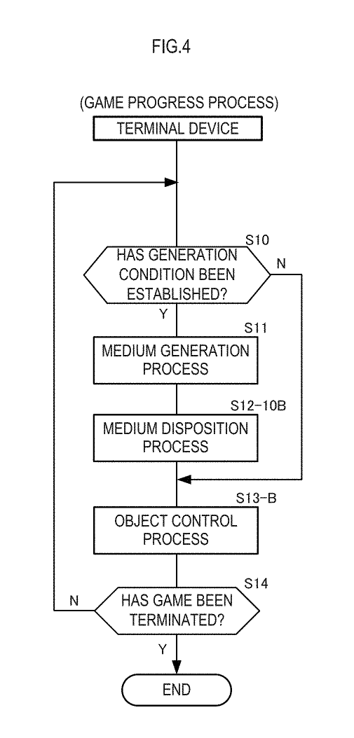

FIG. 4 is a flowchart showing an example of a game progress process which is executed by the terminal device 20B. In the game progress process, a process for progressing the game, such as the generation of the third game medium based on the first game medium and the second game medium, is performed. Meanwhile, in FIG. 4, a process related to the generation of the third game medium is mainly shown, and other game progress processes are not shown.

The execution of the game progress process which is an example of this embodiment is started, for example, with the user's input of an operation of starting the game.

In the game progress process, the terminal device 20B determines whether or not the generation condition has been established (step S10). In a case where the generation condition has not been established (step S10: NO), the terminal device 20B proceeds to the process of step S13-B. On the other hand, in a case where the generation condition has been established (step S10: YES), the terminal device 20B generates the third game medium based on the first game medium and the second game medium (step S11). Next, the terminal device 20B disposes the generated third game medium in a game space (step 912-10B). In the terminal device 20B, for example, a position which is randomly selected in the game space may be set to be a position where the third game medium is disposed. Meanwhile, information regarding the third game medium and the position where the game space is disposed may be stored in the storage unit of the terminal device 20B.

Thereafter, the terminal device 20B performs an object control process (step S13-B). In the object control process, a process of controlling the motion of an object, such as a player object, in the game space is performed. The terminal device 20B controls the motion of the player object on the basis of the user's operation of an operation unit, or the like and, for example, causes the player object to execute an motion of acquiring the third game medium.

Thereafter, the terminal device 20B determines whether or not the game has been terminated (step S14). In a case where the game has not been terminated (step S14: NO), the terminal device 20B returns to the process of step S10. On the other hand, in a case where the game has not been terminated (step S14: YES), the terminal device 20B terminates the game progress process.

As described above, as an aspect of the second embodiment, the terminal device 20B is configured to include the reception unit 31, the generation unit 32, the control unit 33B, and the disposition unit 34B, and thus it is possible to adopt not only a configuration in which the second game medium is received but also a configuration in which the third game medium based on the first game medium and the received second game medium is generated. Therefore, in the game, it is possible to more effectively utilize the received game data (second game medium) and to improve the user's interest in a communication function (wireless communication).

In addition, the generated third game medium is disposed in the game space without being directly given to the user, and thus it is possible to give the user the pleasure of searching for the third game medium in the game space and to more effectively utilize the received game data (second game medium).

Meanwhile, the above-described game space is not particularly limited as long as the game space is a space in which the player object is present. Examples of the game space include a three-dimensional virtual space and a two-dimensional virtual space. In addition, the number of game spaces may be one or two or more. The number of game spaces means the number of game spaces in a unit which is arbitrarily determined. For example, the number of game spaces may be set to be the number of spaces which are specified in different world coordinate systems. Alternatively, one region which is sectioned in advance in a space specified in the same world coordinate system may be set to be one game space.

### Third Embodiment

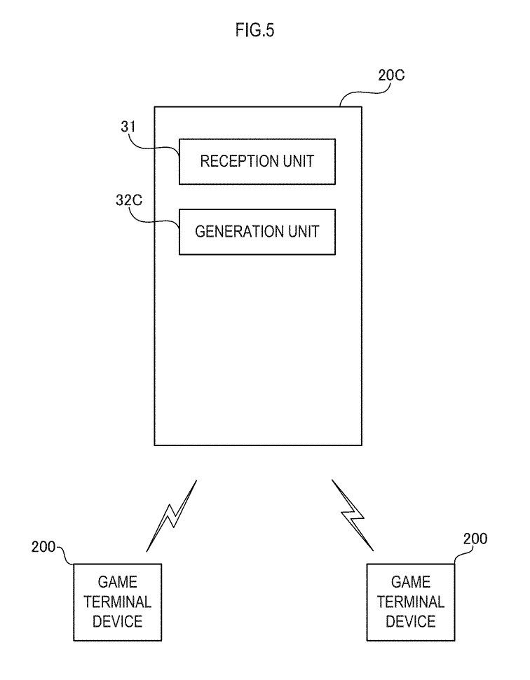

FIG. 5 is a block diagram showing a configuration of a terminal device 20C which is an example of the terminal device 20. In this example, the terminal device 20C includes at least a reception unit 31 and a generation unit 32C.

The reception unit 31 receives information regarding a second game medium from another terminal device 200 through wireless communication. The generation unit 32C generates the third game medium based on the first game medium and the second game medium in accordance with the establishment of a generation condition. In the example of this embodiment, the generation unit 32C counts the number of times of communication with another terminal device 200. The generation unit 32C generates a privilege related to the generated third game medium in accordance with the number of times of communication.

That is, the number of times of communication (the number of times of reception) through which the information regarding the second game medium is received is counted, for each of other users (other terminal devices 200). When the third game medium is generated on the basis of the second game medium received from another user, the privilege is generated in accordance with the number of times of communication with the user.

For example, in a case where the third game medium is generated on the basis of the second game medium received from another user having a large number of times of communication, a privilege of giving a bonus to some parameters of the third game medium is generated. More specifically, a bonus value is added to an upper limit (maximum value) of the vitality of the third game medium and to a parameter of a striking power. Therefore, the worth of the third game medium to be generated increases, as compared to a case where the number of times of communication is small.

Meanwhile, the generation unit 32C may count the number of times of communication by using, for example, identification information of another user. In this case, the reception unit 31 may receive the identification information of another user together with the information regarding the second game medium from another terminal device 200. In addition, identification information (MAC address and the like) of another terminal device 200 may be used instead of the identification information of another user.

Next, the operation of the terminal device 20C which is an example of this embodiment will be described.

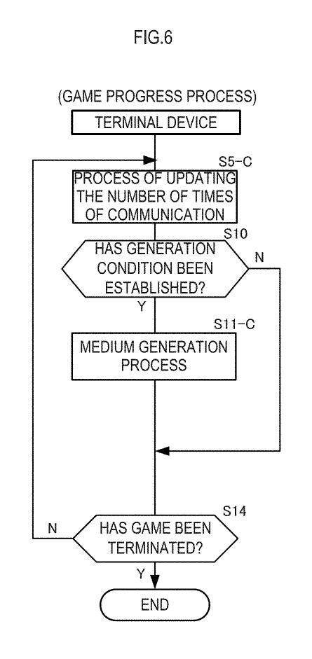

FIG. 6 is a flowchart showing an example of a game progress process which is executed by the terminal device 20C. In the game progress process, a process for progressing the game, such as the generation of the third game medium based on the first game medium and the second game medium, is performed. Meanwhile, in FIG. 6, a process related to the generation of the third game medium is mainly shown, and other game progress processes are not shown.

The execution of the game progress process which is an example of this embodiment is started, for example, with the user's input of an operation of starting the game.

In the game progress process, the terminal device 20C counts (updates) the number of times of communication with another user as described above (step S5-C). For example, after the previous execution of the process of step S5-C, the number of times of communication is updated with reference to identification information of another user which is newly received.

Next, the terminal device 20C determines whether or not the generation condition has been established (step S10). In a case where the generation condition has not been established (step S10: NO), the terminal device 20C proceeds to the process of step S14. On the other hand, in a case where the generation condition has been established (step S10: YES), the terminal device 20C generates the third game medium based on the first game medium and the second game medium (step S11-C). The terminal device 20C also generates a privilege related to the third game medium to be generated, in accordance with the number of times of communication with another user of the second game medium, as described above in the process of step S11-C.

Thereafter, the terminal device 20C determines whether or not the game has been terminated (step S14). In a case where the game has not been terminated (step S14: NO), the terminal device 20C returns to the process of step S5-C. On the other hand, in a case where the game has been terminated (step S14: YES), the terminal device 20C terminates the game progress process.

As described above, as an aspect of the third embodiment, the terminal device 20C is configured to include the reception unit 31 and the generation unit 32C, and thus it is possible to adopt not only a configuration in which the second game medium is received but also a configuration in which the third game medium based on the first game medium and the received second game medium is generated. Therefore, in the game, it is possible to more effectively utilize the received game data (second game medium) and to improve the user's interest in a communication function (wireless communication).

In addition, a privilege related to the third game medium is generated in accordance with the number of times of communication with another user, which draws a motivation to repeatedly perform wireless communication with the same user, and thus it is possible to improve the user's interest in the communication function.

Meanwhile, the above-described privilege may adopt any configuration as long as the privilege is a privilege related to the third game medium to be generated. For example, the privilege may be set to be a privilege for generating a plurality of third game mediums. In this case, the plurality of third game mediums may be the same as each other or may be different from each other.

Meanwhile, the terminal device 20C which is an example of this embodiment may include the control unit 33B and the disposition unit 34B in the second embodiment.

### Fourth Embodiment

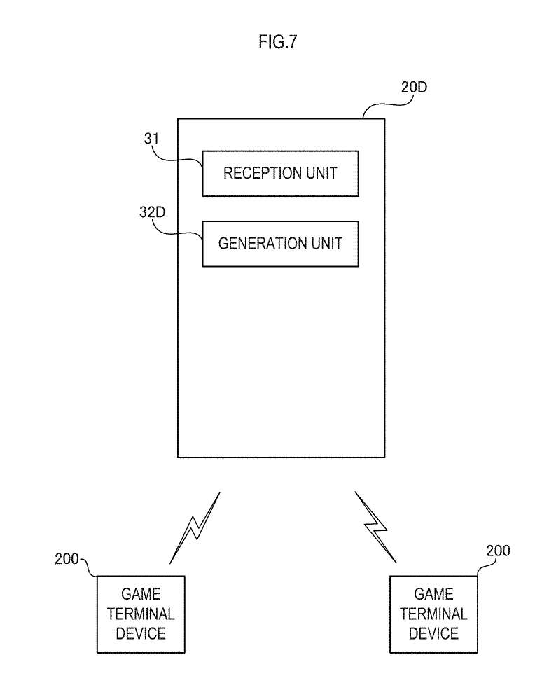

FIG. 7 is a block diagram showing a configuration of a terminal device 20D which is an example of the terminal device 20. In this example, the terminal device 20D includes at least a reception unit 31 and a generation unit 32D.

The reception unit 31 receives information regarding the second game medium from another terminal device 200 through wireless communication. The generation unit 32D generates the third game medium based on the first game medium and the second game medium in accordance with the establishment of a generation condition. In the example of this embodiment, in a case where a second game medium used for the generation of the third game medium is not present, the generation unit 32D uses a substitute game medium as the second game medium. That is, in a case where the second game medium cannot be used, the third game medium is generated on the basis of the first game medium and the substitute game medium. Further, the generation unit 32D generates the substitute game medium. Meanwhile, the generated substitute game medium may be stored in a storage unit of the terminal device 20D.

Next, the operation of the terminal device 20D which is an example of this embodiment will be described.

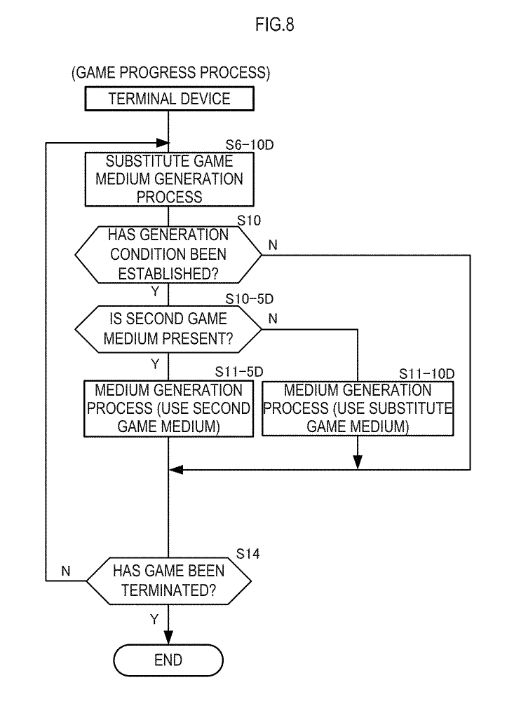

FIG. 8 is a flowchart showing an example of a game progress process which is executed by the terminal device 20D. In the game progress process, a process for progressing the game, such as the generation of the third game medium based on the first game medium and the second game medium, is performed. Meanwhile, in FIG. 8, a process related to the generation of the third game medium is mainly shown, and other game progress processes are not shown.

The execution of the game progress process which is an example of this embodiment is started, for example, with the user's input of an operation of starting the game.

In the game progress process, the terminal device 20D generates the substitute game medium as described above (step S6-10D). For example, the terminal device 20D generates a new substitute game medium for each elapse of a predetermined period of time in the process of step S6-10D. Alternatively, a new substitute game medium may be generated in a case where a second game medium is not received even when a fixed period of time elapses.

Next, the terminal device 20D determines whether or not the generation condition has been established (step S10). In a case where the generation condition has not been established (step S10: NO), the terminal device 20D proceeds to the process of step S14. On the other hand, in a case where the generation condition has been established (step S10: YES), the terminal device 20D determines whether or not the second game medium is present (step S10-5D). For example, when information regarding the second game medium is not stored in the storage unit of the terminal device 20D, it may be determined that the second game medium is not present.

In a case where it is determined that the second game medium is present (step S10-5D: YES), the terminal device 20D generates the third game medium based on the first game medium and the second game medium (step S11-5D). On the other hand, in a case where it is determined that the second game medium is not present (step S10-5D: NO), the terminal device 20D generates the third game medium based on the first game medium and the substitute game medium (step S11-10D).

Thereafter, the terminal device 20D determines whether or not the game has been terminated (step S14). In a case where the game has not been terminated (step S14: NO), the terminal device 20C returns to the process of step S6-D. On the other hand, in a case where the game has been terminated (step S14: YES), the terminal device 20D terminates the game progress process.

As described above, as an aspect of the fourth embodiment, the terminal device 20D is configured to include the reception unit 31 and the generation unit 32D, and thus it is possible to adopt not only a configuration in which the second game medium is received but also a configuration in which the third game medium based on the first game medium and the received second game medium is generated. Therefore, in the game, it is possible to more effectively utilize the received game data (second game medium) and to improve the user's interest in a communication function (wireless communication).

In a case where the second game medium is not present, the third game medium is generated on the basis of the first game medium and the substitute game medium. Therefore, for example, even in a case of an environment in which another user (another terminal device 200) is not present in the surroundings in the real space and the frequency of reception of information regarding the second game medium is low, it is possible to suppress a decrease in the user's interest in a communication function.

Meanwhile, the above-described substitute game medium does not need to be stored in the storage unit at all times. In addition, the substitute game medium which is used once may be deleted from the storage unit or may be set to be unusable again. In addition, the substitute game medium may be used as a substitute for the first game medium. For example, in a case where the first game medium is not set, the substitute game medium is used as the first game medium.

In addition, a case where the above-described second game medium is not present means a case where the second game medium which is usable for the generation of the third game medium is not present. For example, in a configuration in which the second game medium that has already been used for the generation of the third game medium cannot be used again, a case where only the second game medium that has already been used is stored in the storage unit corresponds to a case where the above-described second game medium is not present.

Meanwhile, the terminal device 20D which is an example of this embodiment may include the control unit 33B and the disposition unit 34B in the second embodiment. In the terminal device 20D which is an example of this embodiment, a configuration in which a privilege is generated by the generation unit 32C in the third embodiment may be applied to the generation unit 33D.

### Fifth Embodiment

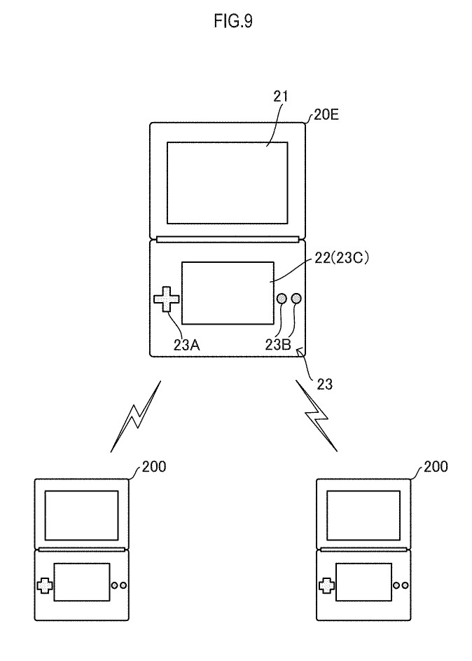

FIG. 9 is a diagram showing the exterior of a terminal device 20E which is an example of the terminal device 20. The terminal device 20E which is an example of this embodiment is a portable game device having a communication function for wirelessly communicating with another terminal device 200 positioned in a communicable range by using a communication system of Wi-Fi. In addition, the terminal device 20E includes a first display unit 21, a second display unit 22, an operation unit 23, and the like.

The first display unit 21 and the second display unit 22 are liquid crystal display devices, and display a game image of a game to be executed. The operation unit 23 receives a user's operation input. The operation unit 23 includes, for example, cross keys 23A, buttons 23B, a touch panel 23C disposed on the surface of the second display unit 22, and the like.

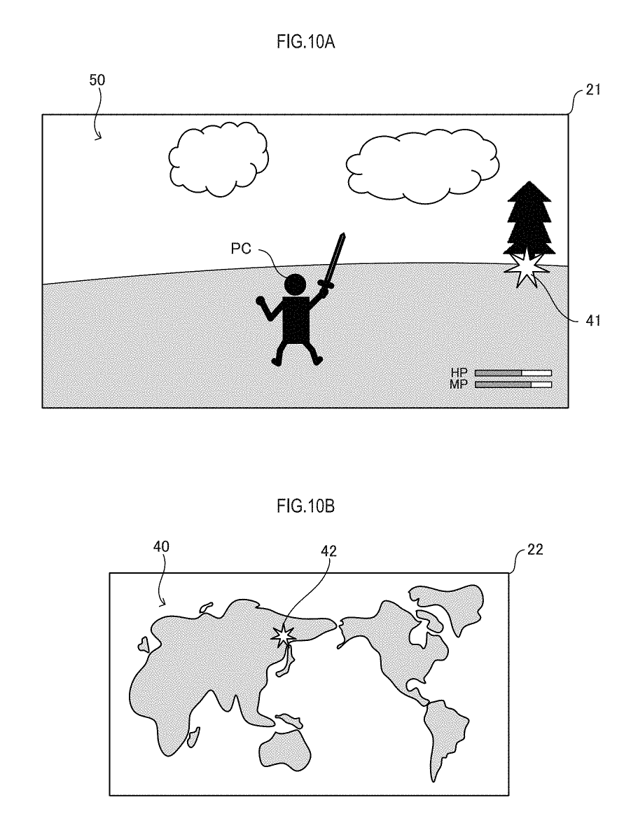

The terminal device 20E executes an application program (game program) which is stored in a storage unit (not shown) of the terminal device 20E to respectively display game images as shown in FIGS. 10A and 10B on the first display unit 21 and the second display unit 22 and provide the game to the user. FIGS. 10A and 10B are diagrams showing examples of a game image.

The game image of FIG. 10A is an image of a game space 50 including a player character (player object) PC, and is displayed on the first display unit 21. In addition, the game image of FIG. 10B is an image of a map 40 of the entire game space 50, and is displayed on the second display unit 22.

In the example of this embodiment, the game is executed in which the player character PC moves in the game space 50 which is a three-dimensional virtual space to fight with an enemy object and the like. The user operates the operation unit 23 to instruct the player character PC to perform an motion such as movement or an attack. In addition, the user can also instruct the player character PC to perform an motion of acquiring a predetermined object disposed in the game space (acquisition motion). An example of the predetermined object is a party character (game medium). The user can possess the acquired party character.

A symbol object 41 as shown in FIG. 10A is disposed at a position where the party character is disposed in the game space 50. The player character PC can move to the vicinity of the symbol object 41 and performs an acquisition motion to acquire a party character corresponding to the symbol object 41. Meanwhile, the acquired party character is deleted from the game space 50, and thus a corresponding icon object 41 is also eliminated.

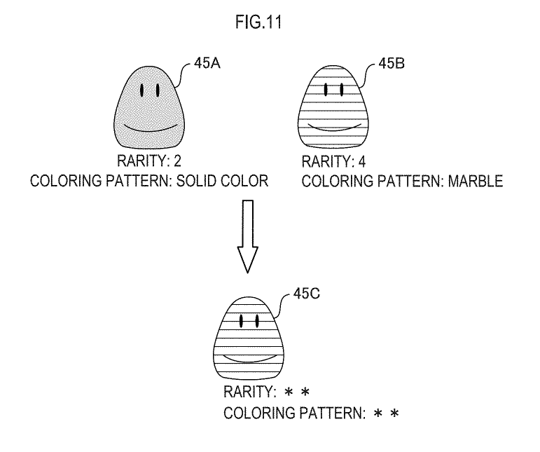

The party character has a form as shown in FIG. 11, and has a parameter, such as a rarity, set therein. A plurality of types of party characters having different parameter setting contents are present. Information regarding the party character is included in game data. In addition, whenever a predetermined condition is established, any party character is disposed at any position in the game space 50. That is, the party character appears in the game space 50 on a regular basis.

In the example of this embodiment, the party character searches for an item usable for the progress of the game by the user, and the like in a game space (not shown) to which the player character PC cannot go, in accordance with an instruction received from the user who is a possessor. The item acquired by the search is given to the user (is possessed by the user). The party character can fight a battle with an enemy character that the party character encounters, during the search. In the battle, in a case where the present value of vitality of the party character is equal to or less than a predetermined value, an action disable state is set and the party character disappears, and thus it is not possible to progress the search.

The game space where the party character performs the search is a dungeon such as a cave, and a plurality of stories are formed toward underground. Although an enemy character having a greater ability is present in the deepest portion (lowermost layer) of the dungeon, an item with higher worth is also disposed.

In addition, the user can transmit the user's party character to another user (another terminal device 200). In addition, the user can receive a party character possessed by the another user from the another user (another terminal device 200). The user can set one of the user's party characters to be a party character for transmission. In the example of this embodiment, the terminal device 20E and the another terminal device 200 automatically detect each other by using wireless communication and automatically transmit and receive information regarding a party character which is set for transmission with respect to the detected party. That is, so-called StreetPass Communication is performed.

Hereinafter, in the terminal device 20E, a party character which is set for transmission will be referred to as a first game medium, and a party character received from another user will be referred to as a second game medium.

The second game medium may be possessed by the user as a party character. In addition, as shown in FIG. 11, a second game medium 45B may be used to generate a blend party character 45C together with a first game medium 45A. FIG. 11 is a diagram showing the generation of the blend party character 45C. Hereinafter, the blend party character 45C will be referred to as a third game medium 45C.

The third game medium 45C is included in a party character, and is generated on the basis of the first game medium 45A and the second game medium 45B in accordance with the establishment of a generation condition. In addition, the generated third game medium 45C is disposed in the game space 50 whenever a disposition condition is established. The player character PC can acquire the third game medium 45C disposed in the game space 50 through an acquisition motion.

Meanwhile, in the example of this embodiment, in a case where the user performs an operation of possessing the second game medium 45B as a party character, the second game medium 45B is excluded from an object which is used for the generation of the third game medium 45C. In a case where the second game medium 45B is not present, a substitute game medium is used for the generation of the third game medium 45C as the second game medium 45B.

As generation conditions, the following conditions A1 to A3 can be established.

Condition A1: the first game medium 45A is set

Condition A2: the second game medium 45B (or a substitute game medium) is present

Condition A3: a fixed period of time elapses from the previous generation of the third game medium 45C, or the player character PC moves to another game space 50

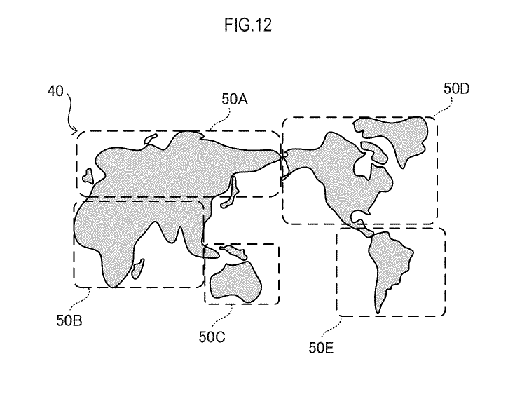

The “movement” in the condition A3 means that the player character PC moves to a game space 50 different from the game space 50 in which the player character PC is present. The game space 50 which is an example of this embodiment is constituted by a plurality of game spaces 50A to 50E as shown in FIG. 12. For example, in a case where the player character PC moves from a game space 50A to a game space 50E, the condition A3 is established.

In the example of this embodiment, a maximum of five third game mediums 45C generated are stocked in the storage unit of the terminal device 20E. In the example of this embodiment, one third game medium 45C is randomly selected among the stocked third game mediums 45C whenever the disposition condition is established. The selected third game medium 45C is disposed at a position which is randomly selected among a plurality of disposition positions which are set in advance in the game spaces 50A to 50E.

When the third game medium 45C is disposed in the game space 50, the symbol object 41 is disposed at a corresponding position in the game space 50. In addition, a symbol mark 42 is displayed at a position corresponding to the position where the third game medium 45C is disposed in the map 40. Meanwhile, the form such as the color and the shape of each of the symbol object 41 and the symbol mark 42 can be arbitrarily set.

The external shape is common to the third game mediums 45C to be generated, but each of parameters such as a name, a rarity, coloring, vitality, and a striking power is uniquely set. Some of the parameters are determined on the basis of some of the parameters of each of the first game medium 45A and the second game medium 45B. Therefore, the user is motivated to collect various party characters so that the third game medium 45C with higher worth is generated.

In the example of this embodiment, a privilege related to the third game medium is generated in accordance with the number of times of communication with another user (the number of times of reception of the second game medium 45B). Specifically, a bonus is given to some parameters of the third game medium 45C. Details thereof will be described later.

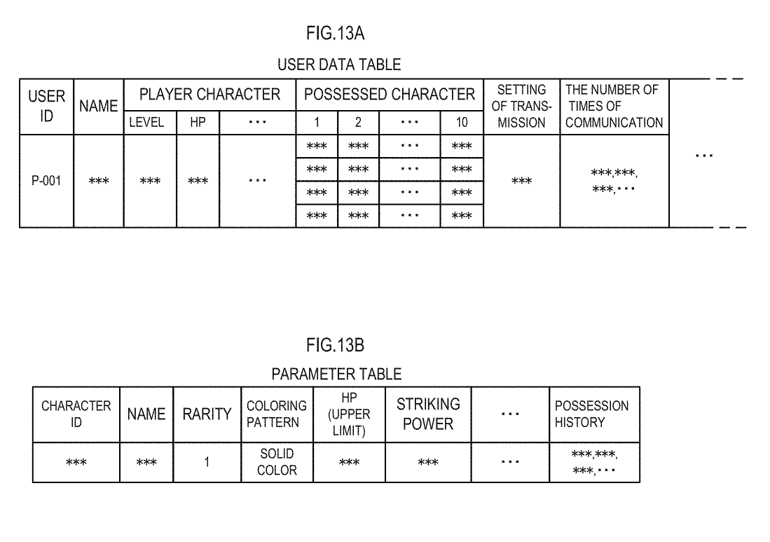

Next, a user data table will be described with reference to FIGS. 13A and 13B. FIG. 13A is a diagram showing an example of the user data table. In addition, FIG. 13B is a diagram showing an example of a parameter table.

In the user data table, information regarding the game of the user of the terminal device 20E is set, and the user data table is stored in the storage unit of the terminal device 20E. The user data table is constituted by fields such as a user ID, a name, a player character, a possessed character, setting of transmission, and the number of times of communication. In the field of the user ID, a user ID which is identification information for specifying a user is set. In the field of the name, text data which is a name of a user in the game is set. In the field of the player character, parameters such as a level and an upper limit of vitality, and information regarding a player character PC such as image information are set. In the field of the possessed character, information regarding each party character possessed by the user is set. The user can stock, for example, a maximum of 10 party characters. As the information regarding the party character, parameters as shown in the parameter table of FIG. 13B, and the like are set. Meanwhile, the acquired third game medium 45C is also managed in the field of the party character.

In the field of the setting of transmission, a character ID which is identification information of a party character (first game medium 45A) for transmission is set. The user can operate the operation unit 23 to designate a party character for transmission among the party characters set in the possessed character and to designate non-transmission. In the field of the number of times of communication, information regarding the number of times of communication with another user is set. For example, information having identification information of another user and the number of times of communication associated with each other is set. The number of times of communication is updated whenever information regarding the second game medium 45B is received.

Next, parameters of a party character such as the third game medium 45C will be described with reference to FIG. 13B.

The parameter table is constituted by fields such as a character ID, a name, a rarity, vitality (HP), and a possession history. In the field of the character ID, a character ID which is identification information for specifying the party character is set. In the field of the name, text data serving as the name of the party character is set. In the field of the rarity, a numerical value indicating the degree of rarity of the party character is set. For example, the rarity has 1 to 8 levels, and the degree of rarity increases as the number becomes larger.

In a field of a coloring pattern, a coloring pattern of the surface of the party character is set. In the example of this embodiment, any one of three types of coloring patterns of a solid color, a marble, and a metal is set. The solid color indicates that the surface of the party character is formed of a single color. The marble indicates that the surface of the party character is formed of a striped pattern of two colors. The metal indicates that the surface of the party character is formed of a single color expressing a metal. In the field of the vitality, an upper limit of the vitality of the party character is set. In the field of the striking power, a numerical value of a striking power of the party character is set. In the field of the possession history, text data which is a name of a user who was a possessor in the past is set. For example, names of a maximum of five past possessors are set.

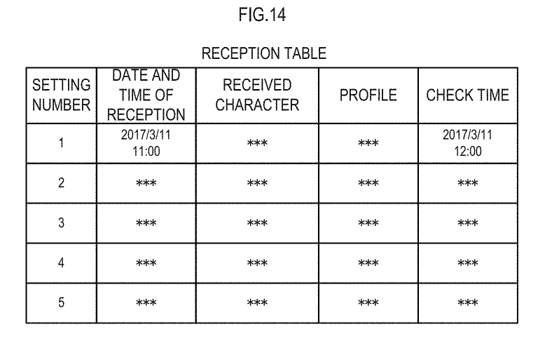

Next, received information of the second game medium will be described with reference to FIG. 14. FIG. 14 is a diagram showing an example of a reception table.

In the reception table, information received from another user (another terminal device 200) is set, and the reception table is stored in the storage unit of the terminal device 20E. The reception table is constituted by fields such as a setting number, a date and time of reception, a received character, a profile, and a check time. In the field of the setting number, a management number which is the number of stocks is set. In the example of this embodiment, a maximum of five second game mediums 45B are stocked. In the field of the date and time of reception, a date and time when information is received is set.

In the field of the received character, parameters of the second game medium 45B are set. The parameters are the parameters shown in FIG. 13B. In the field of the profile, information regarding another user who transmits the second game medium 45B is set. For example, the information is a user ID or a name. In the field of the check time, a date and time when the terminal device 20E refers to the second game medium 45B when generating the third game medium 45C is set. Therefore, it is possible to determine that the second game medium 45B having no reference date and time set therein is a second game medium 45B which is newly received.

The terminal device 20E updates the fields of the date and time of reception, the received character and the profile when receiving information regarding the second game medium through wireless communication. Meanwhile, in a case where the terminal device 20E receives a sixth second game medium, the terminal device may perform overwriting in a data region in which the date and time of reception is oldest.

The terminal device 20E sets all second game mediums having no date and time of a check time set therein as selection candidates with reference to the reception table in a case where a generation condition has been established, and selects one second game medium 45B in which the date and time of reception is oldest among the selection candidates. The terminal device 20E generates the third game medium 45C on the basis of the first game medium 45A and the selected second game medium 45B. After the generation, the terminal device 20E performs the setting of a date and time in the field of the check time on all of the second game mediums 45B which are selection candidates. Therefore, even when the second game medium 45B is a selection candidate but is not selected, the second game medium is not used for the subsequent generation of the third game medium 45C. That is, in the example of this embodiment, only the second game medium 45B received between the subsequent generation of the third game medium 45C and the present generation of the third game medium 45C is set to be a selection candidate.

Meanwhile, anyone of the second game mediums 45B managed in the reception table may be randomly selected without determining a selection candidate. In addition, the second game medium 45B being managed in the reception table may be used again for the generation of the third game medium 45C.

In addition, when the user performs an operation of possessing the second game medium 45B in the reception table, setting information of the possessed character in the user data table is updated, and information of the corresponding received character in the reception table is erased (is reset to a non-setting state).

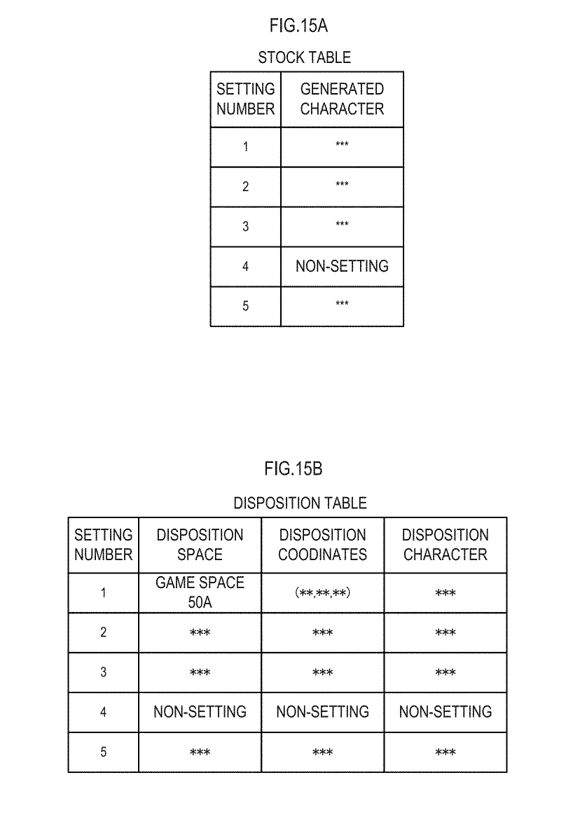

The terminal device 20E manages the third game medium 45C which is generated and is not disposed in the game space 50 by a stock table as shown in FIG. 15A. The stock table is constituted by fields such as a setting number and a generated character. In the field of the setting number, a management number which is the number of stocks is set. In the example of this embodiment, a maximum of five third game mediums 45C are stocked as described above. In the field of the generated character, parameters of the third game medium 45C are set as shown in FIG. 13B.

In a case where a disposition condition has been established, the terminal device 20E disposes one third game medium 45C, which is randomly selected with reference to the stock table, in the game space 50. Specifically, information regarding the selected third game medium 45C is set in a disposition table shown in FIG. 15B. In addition, the terminal device 20E erases information regarding a generated character having a setting number corresponding to the selected third game medium 45C from the stock table (performs reset to a non-setting state).

In the disposition table, information for managing the third game medium 45C disposed in the game space 50 is set, and the disposition table is stored in the storage unit of the terminal device 20E.

The disposition table is constituted by fields such as a setting number, a disposition space, disposition coordinates, and a disposition character. In the field of the setting number, a management number which is the number of dispositions is set. In the example of this embodiment, the third game medium 45C is disposed at a maximum of five locations. In the field of the disposition space, information for specifying game spaces 50A to 50E for disposition is set. In the field of the disposition coordinates, information regarding the coordinates of the game space 50 for disposition is set. In the field of the disposition character, parameters of the third game medium 45C to be disposed are set. The terminal device 20E erases each information regarding a setting number corresponding to a third game medium 45C acquired (performs reset to a non-setting state) from the disposition table in a case where the third game medium 45C is acquired by the player character PC.

In addition, the terminal device 20E disposes the symbol object 41 in the game space 50 with reference to the disposition table, and displays the symbol mark 42 on the map 40.

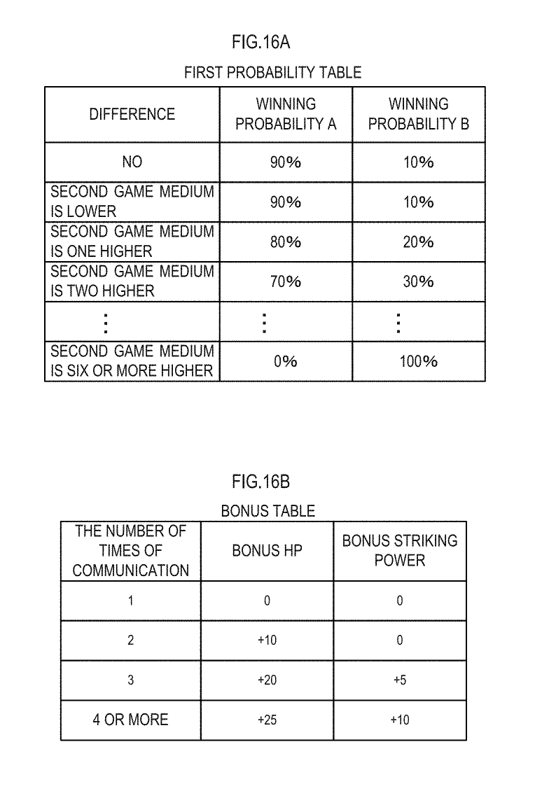

Next, the generation of the third game medium 45C will be described in detail with reference to FIG. 11 and FIGS. 16A and 16B. FIGS. 16A and 16B are diagrams respectively showing examples of a first probability table and a bonus table.

In the example of this embodiment, as described above, at least some parameters of the third game medium 45C are determined using some parameters of each of the first game medium 45A and the second game medium 45B. More specifically, the terminal device 20E determines the rarity and coloring pattern of the third game medium 45C by using the rarity and coloring pattern of each of the first game medium 45A and the second game medium 45B.

First, a method of determining a rarity will be described. In the third game medium 45C, one rarity higher or the same rarity is set for the rarity of the first game medium 45A. Which rarity is set is determined by the drawing of lots. The drawing of lots is executed using a corresponding winning probability (predetermined probability) from a first probability table shown in FIG. 16A. The first probability table is constituted by a field of a difference and fields of winning probabilities A and B. In the field of the difference, information regarding a difference between the rarity of the first game medium 45A and the rarity of the second game medium 45B is set. In the field of the winning probability A, a winning probability (%) of setting the same rarity as the rarity of the first game medium 45A is set. Regarding the winning probability B, a winning probability (%) of setting one rarity higher than the rarity of the first game medium 45A is set. That is, the drawing of lots is performed with a winning probability based on the corresponding difference.

For example, in a case where the first game medium 45A and the second game medium 45B are the same as each other, a probability that the same rarity as the rarity of the first game medium 45A is set is 90%. In addition, a winning probability of setting one rarity higher than the rarity of the first game medium 45A increases as the rarity of the second game medium 45B becomes greater than the rarity of the first game medium 45A.

Next, a method of determining a coloring pattern will be described. Regarding the coloring pattern, any one of three types (a solid color, a marble, and a metal) is determined by the drawing of lots. The drawing of lots is executed using a corresponding winning probability from a second probability table (not shown). For example, a winning probability corresponding to a combination of a coloring pattern of the first game medium 45A and a coloring pattern of the second game medium 45B is used.

In addition, the determined rarity and coloring pattern are used for the determination of other parameters of the third game medium 45C such as vitality and a striking power. For example, a higher upper limit of the vitality and a higher striking power are set as the rarity becomes higher. In addition, the nature of the third game medium 45C is determined by the rarity and the coloring pattern.

In addition, the terminal device 20E gives the above-described bonus based on the number of times of communication to the third game medium 45C on the basis of the bonus table shown in FIG. 16B. The bonus table is constituted by fields such as the number of times of communication, a bonus HP, and a bonus striking power. In the field of the number of times of communication, a condition value of the number of times of communication for the giving of a bonus is set. In the field of the bonus HP, a value (bonus value) to be added to an upper limit of vitality is set. In the field of the bonus striking power, a value (bonus value) to be added to the striking power is set.

As shown in FIG. 16B, as the number of times of communication increases, a bonus value to be added to the upper limit of vitality and the striking power becomes larger. For example, when the number of times of communication is 3 in a case where the upper limit of vitality of the third game medium 45C to be generated is 50, (50+20) is set to be the upper limit of vitality.

Next, a substitute game medium will be described. As described above, in a case where the second game medium 45B is not present, the substitute game medium is used as a substitute for the second game medium 45B. The substitute game medium is generated by the terminal device 20E and is stored in the storage unit. The substitute game medium has the same types of parameters as those of a party character. For example, the terminal device 20E randomly determines the value of each parameter to generate the substitute game medium. For example, the generation of the substitute game medium may be executed in a case where the second game medium 45B has not been received even when a fixed period of time elapses.

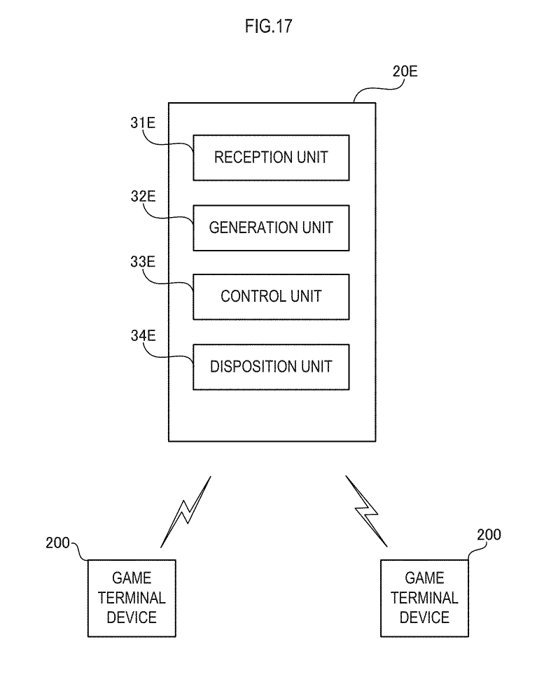

FIG. 17 is a block diagram showing an example of a configuration of the terminal device 20E which is an example of the terminal device 20. In this example, the terminal device 20E includes at least a reception unit 31E, a generation unit 32E, a control unit 33E, and a disposition unit 34E.

The reception unit 31E receives information regarding the second game medium 45B, such as parameters, from another terminal device 200 through wireless communication. In addition, the reception unit 31E receives information (profile) regarding another user who possesses the second game medium 45B. In addition, the reception unit 31E updates the reception table on the basis of the received information regarding the second game medium 45B and the like. The generation unit 32E generates the third game medium 45C based on the first game medium 45A and the second game medium 45B in accordance with the establishment of a generation condition. As described above, the generation unit 32E determines parameters of the third game medium 45C, such as a rarity, from the parameters of the first game medium 45A and the second game medium 45B such as a rarity. Further, the generation unit 32E generates a privilege (bonus) related to the third game medium 45C to be generated, in accordance with the number of times of communication.

The control unit 33E controls the motion of the player character PC operated by the user in the game space 50. The disposition unit 34E disposes the generated third game medium 45C in the game space 50 so that the player character PC can acquire the third game medium, in accordance with a disposition condition.

Next, the operation of the terminal device 20E which is an example of this embodiment will be described.

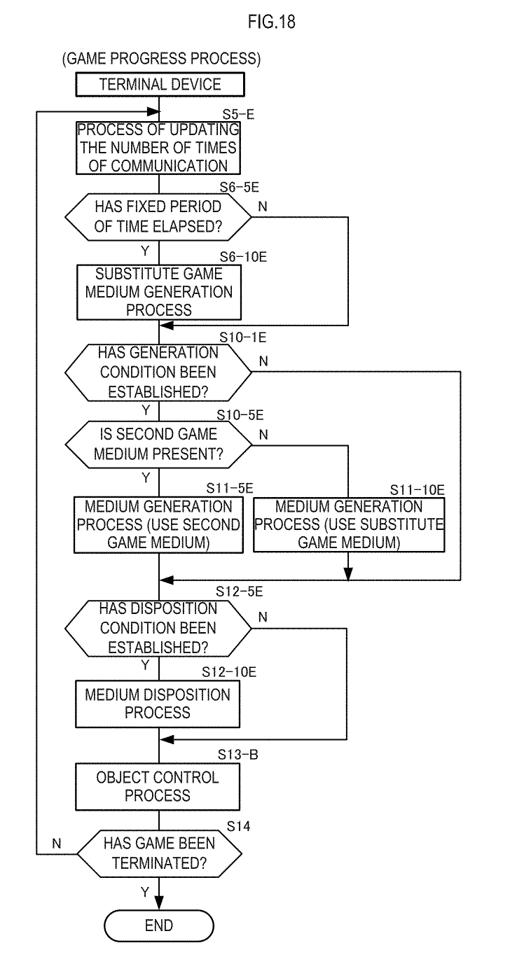

FIG. 18 is a flowchart showing an example of a game progress process executed by the terminal device 20E. In the game progress process, a process for progressing the game, such as the generation of the third game medium 45C based on the first game medium 45A and the second game medium 45B, is performed. Meanwhile, in FIG. 18, a process related to the generation of the third game medium 45C is mainly shown, and other game progress processes are not shown.

The execution of the game progress process which is an example of this embodiment is started, for example, with the user's input of an operation of starting the game.

In the game progress process, the terminal device 20E counts (updates) the number of times of communication with another user as described above (step S5-E). The terminal device 20E specifies identification information of another user which is received after the subsequent execution of the process of step S5-E, for example, with reference to the reception table. Thereafter, the terminal device 20E updates the field of the number of times of communication in the user data table.

Next, the terminal device 20E determines whether or not a fixed period of time has elapsed in a state where the second game medium 45B is not received (step S6-5E). The fixed period of time may be set to, for example, one day (24 hours). In a case where it is determined that the fixed period of time has not elapsed (step S6-5: NO), the terminal device 20E proceeds to the process of S10-1E. On the other hand, in a case where it is determined that the fixed period of time has elapsed (step S6-5E: YES), the terminal device 20E generates a substitute game medium as described above (step S6-10E). Meanwhile, in a case where a substitute game medium has been already generated and is stored in the storage unit, the stored substitute game medium may be erased, and a newly generated substitute game medium may be stored in the storage unit.

Thereafter, the terminal device 20E determines whether or not the generation condition has been established (step S10-1E). The terminal device 20E performs the determination with reference to the user data table, a movement flag, and the like. Meanwhile, regarding the movement flag, 1 is set as a numerical value for specifying the movement of the player character PC in a case where the player character PC has moved to another game space 50. In a case where the generation condition has not been established (step S10-1E: NO), the terminal device 20E proceeds to the process of step S12-5E. On the other hand, in a case where the generation condition has been established (step S10-1E: YES), the terminal device 20E determines whether or not the second game medium 45B is present (step S10-5E). The terminal device 20E performs the determination with reference to the reception table and the like, as described above.

In a case where it is determined that the second game medium 45B is present (step S10-5E: YES), the terminal device 20E generates the third game medium 45C based on the first game medium 45A and the second game medium 45B (step S11-5E). On the other hand, in a case where it is determined that the second game medium 45B is not present (step S10-5E: NO), the terminal device 20E generates the third game medium 45C based on the first game medium 45A and the substitute game medium (step 511-10E).

Next, the terminal device 20E determines whether or not the disposition condition of the third game medium 45C has been established (step S12-5E). The terminal device 20E determines whether or not the player character PC has moved to another game space 50 (disposition condition), with reference to the movement flag.

In a case where the disposition condition has not been satisfied (step 512-5E: NO), the terminal device 20E proceeds to the process of step S13-E. On the other hand, in a case where the disposition condition has been satisfied (step 512-5E: YES), the terminal device 20E disposes the third game medium 45C in the game space 50 (step S12-10E). As described above, the terminal device 20E sets one third game medium 45C selected from the stock table in the disposition table and updates the stock table. Further, the terminal device 20E resets the value of the movement flag from 1 to 0.

Thereafter, the terminal device 20E performs an object control process (step S13-E). In the object control process, a process of controlling the motion of an object, such as the player character PC, in the game space 50 is performed. The terminal device 20E controls the motion of the player character PC on the basis of the user's operation of an operation unit, or the like and, for example, causes the player character PC to execute an motion of acquiring the third game medium 45C. Thereby, the user data table and the disposition table are updated. In addition, the terminal device 20E sets the movement flag from 0 to 1 in a case where the player character PC is moved to another game space 50.

Thereafter, the terminal device 20E determines whether or not the game has been terminated (step S14). In a case where the game has not been terminated (step S14: NO) the terminal device 20E returns to the process of step S5-E. On the other hand, in a case where the game has been terminated (step S14: YES), the terminal device 20E terminates the game progress process.

As described above, as an aspect of the fifth embodiment, the terminal device 20E is configured to include the reception unit 31E, the generation unit 32E, the control unit 33E, and the disposition unit 34E, and thus it is possible to adopt not only a configuration in which the second game medium 45B is received but also a configuration in which the third game medium 45C based on the first game medium 45A and the received second game medium 45B is generated. Therefore, in the game, it is possible to more effectively utilize the received game data (the second game medium 45B) and to improve the user's interest in a communication function (wireless communication).

In a case where the second game medium 45B is not present, the third game medium 45C is generated on the basis of the first game medium 45A and the substitute game medium. Therefore, for example, even in a case of an environment in which another user (another terminal device 200) is not present in the surroundings in the real space and the frequency of reception of information regarding the second game medium 45B is low, it is possible to suppress a decrease in the user's interest in a communication function.

Further, the third game medium 45C is disposed in the game space 50 without being directly given to the user, and thus it is possible to give the user the pleasure of searching for the third game medium 45C in the game space 50 and to more effectively utilize the received game data (second game medium 45B). In addition, a privilege (bonus) related to the third game medium 45C to be generated is generated in accordance with the number of times of communication with another user, which draws a motivation to repeatedly perform wireless communication with the same user, and thus it is possible to improve the user's interest in a communication function.

In addition, the third game medium 45C is generated on the basis of parameters of the first game medium 45A of the user and the second game medium 45B of another user, and thus the user is motivated to acquire various high party characters. In addition, the reception of various second game mediums 45B draws a motivation to activate activity in the real space.

Meanwhile, in the example of the above-described embodiment, a configuration is adopted in which the third game medium 45C can be acquired by an acquisition motion of the player character PC, but an acquisition motion may be performed by the user.

In addition, the above-described third game medium 45C is determined on the basis of the first game medium 45A and the second game medium 45B with respect to some parameters, but is not particularly limited thereto. For example, like so-called strengthening composition, a game medium obtained by strengthening parameters of a first game medium which is a base on the basis of a second game medium may be set to be a third game medium. In addition, a weapon and a protector equipped by the third game medium may be set to be weapons and protectors equipped by the first game medium and the second game medium.

Regarding the above-described rarity of the third game medium 45C, one rarity higher than the rarity of the first game medium 45A is set to be the maximum rarity, but is not limited thereto. For example, the higher rarity out of the rarities of the first game medium and the second game medium may be set to be the rarity of the third game medium. In this case, adjustment (restriction) may be applied to the third game medium to be generated, in accordance with the degree of progress of the game of the user.

For example, a parameter of an upper limit of vitality of the third game medium is adjusted in accordance with a progression level (arrival level) of a dungeon searched for by a party character. In a case where the progression level is a low level (equal to or less than level 3) and the rarity of the generated third game medium is high (equal to or higher than 5), the upper limit of vitality of the third game medium is set to a predetermined value lower than the original upper limit. In addition, the adjustment may be canceled in accordance with the subsequent degree of progress of the game.

In addition, parameters of the second game medium to be received may be adjusted in accordance with the degree of progress of the game. Specifically, parameters of the second game medium possessed by the user are adjusted. For example, a parameter of an upper limit of vitality of the possessed second game medium is adjusted in accordance with a progression level (arrival level) of a dungeon searched for by a party character. In a case where the progression level is a low level (equal to or less than level 3) and the rarity of the second game medium is high (equal to or higher than 5), the upper limit of vitality of the second game medium is set to a predetermined value lower than the original upper limit. In addition, the adjustment may be canceled in accordance with the subsequent degree of progress of the game.

### Appendixes

The above embodiments have been described so that a person skilled in the art can implement at least the following inventions.

[1] A game program causing a portable computer capable of wirelessly communicating with another computer positioned in a communicable range to realize a function of controlling progress of a video game using a first game medium possessed by a user, the game program causing the computer to realize:

a reception function of receiving information regarding a second game medium from the another computer through wireless communication; and

a generation function of generating a third game medium based on the first game medium and the second game medium in accordance with establishment of a generation condition.

[2] The game program according to [1], causing the computer to further realize:

a control function of controlling motion of a player object operated by the user in a game space; and

a disposition function of disposing the third game medium in the game space so that the player objector the user is able to acquire the third game medium.

[3] The game program according to [1] or [2],

wherein the generation function realizes a function of counting the number of times of communication with the another user and a function of generating a privilege related to the generated third game medium in accordance with the number of times of communication.

[4] The game program according to any one of [1] to [3],

wherein the generation function realizes a function of generating a substitute game medium and a function of using the substitute game medium as the second game medium in a case where the second game medium used for the generation of the third game medium is not present.

[5] The game program according to [2],

wherein the generation condition includes movement of the player object from the present game space to another game space.

[6] The game program according to any one of [1] to [5],

wherein the information regarding the second game medium includes parameters of the second game medium, and

wherein the generation function realizes a function of determining parameters of the third game medium on the basis of parameters of the first game medium and the parameters of the second game medium.

[7] The game program according to [6],

wherein the generation function realizes a function of adjusting at least some of the parameters of the third game medium which are determined on the basis of the parameters of the first game medium and the parameters of the second game medium in accordance with a degree of progress of the game of the user before the third game medium is generated.

[8] The game program according to [7], causing the computer to further realize:

a cancellation function of cancelling the adjustment in accordance with the present degree of progress of the game.

[9] The game program according to any one of [6] to [8],

wherein the parameters include a rarity, and

wherein the generation function realizes a function of setting the rarity of the third game medium to be equal to or higher than the rarity of the first game medium.

[10] The game program according to [9],

wherein the generation function realizes a function of performing drawing of lots regarding whether to set the rarity of the generated third game medium to be higher than or to be equal to the rarity of the first game medium on the basis of a predetermined probability, and a function of determining the predetermined probability on the basis of a difference between the rarity of the first game medium and the rarity of the second game medium.

[11] The game program according to [10],

wherein the predetermined probability realizes a function of increasing a winning probability of setting the rarity of the third game medium to be higher than the rarity of the first game medium as the rarity of the second game medium becomes higher than the rarity of the first game medium.

[12] The game program according to [3],

wherein the privilege increases a predetermined parameter of the third game medium.

The game program according to any one of [1] to [12],

wherein the generation function realizes a function of preventing the second game medium used once for the generation of the third game medium from being used again for the generation of the third game medium.

[14] The game program according to any one of [1] to [13],

wherein the first game medium and the second game medium are maintained in a state before the generation of the third game medium, even after the third game medium is generated.

[15] The game program according to any one of [1] to [14],

wherein the generation function realizes a function of using one second game medium, which is randomly selected, for the generation of the third game medium, in a case where a plurality of the second game mediums are present.

[16] The game program according to any one of [1] to [15],

wherein the generation function realizes a function of generating the third game medium by using one first game medium selected by the user among a plurality of the first game mediums possessed by the user.

[17] A portable game terminal device which is capable of wirelessly communicating with another game terminal device positioned in a communicable range and realizes a function of controlling progress of a video game using a first game medium possessed by a user, the game terminal device including:

a receptionist configured to receive information regarding a second game medium from the another game terminal device through wireless communication; and

a generator configured to generate a third game medium based on the first game medium and the second game medium in accordance with establishment of a generation condition.

A game progress control method of causing a portable computer capable of wirelessly communicating with another computer positioned in a communicable range to control progress of a video game by using a first game medium possessed by a user, the game progress control method including:

a reception process of receiving information regarding a second game medium from the another computer through wireless communication; and

a generation process of generating a third game medium based on the first game medium and the second game medium in accordance with establishment of a generation condition.

According to one of the embodiments of the present invention, the present invention is useful to provide a function of improving a user's interest on a communication function by more effectively utilizing received game data (second game medium).

What is claimed is:

1. A game program causing a portable computer capable of wirelessly communicating with another computer positioned in a communicable range to realize a function of controlling progress of a video game using a first game medium possessed by a user, the game program causing the computer to realize:
a reception function of receiving information regarding a second game medium from the another computer through wireless communication; and
a generation function of generating a third game medium based on the first game medium and the second game medium in accordance with establishment of a generation condition.

2. The game program according to claim 1, causing the computer to further realize:
a control function of controlling motion of a player object operated by the user in a game space; and
a disposition function of disposing the third game medium in the game space so that the player object or the user is able to acquire the third game medium.

3. The game program according to claim 1,
wherein the generation function realizes a function of counting the number of times of communication with the another user and a function of generating a privilege related to the generated third game medium in accordance with the number of times of communication.

4. The game program according to claim 1,
wherein the generation function realizes a function of generating a substitute game medium and a function of using the substitute game medium as the second game medium in a case where the second game medium used for the generation of the third game medium is not present.

5. The game program according to claim 2,
wherein the generation condition includes movement of the player object from the present game space to another game space.

6. The game program according to claim 1,
wherein the information regarding the second game medium includes parameters of the second game medium, and
wherein the generation function realizes a function of determining parameters of the third game medium on the basis of parameters of the first game medium and the parameters of the second game medium.

7. The game program according to claim 6,
wherein the generation function realizes a function of adjusting at least some of the parameters of the third game medium which are determined on the basis of the parameters of the first game medium and the parameters of the second game medium in accordance with a degree of progress of the game of the user before the third game medium is generated.

8. The game program according to claim 7, causing the computer to further realize:
a cancellation function of cancelling the adjustment in accordance with the present degree of progress of the game.

9. The game program according to claim 6,
wherein the parameters include a rarity, and
wherein the generation function realizes a function of setting the rarity of the third game medium to be equal to or higher than the rarity of the first game medium.

10. The game program according to claim 9,
wherein the generation function realizes a function of performing drawing of lots regarding whether to set the rarity of the generated third game medium to be higher than or to be equal to the rarity of the first game medium on the basis of a predetermined probability, and a function of determining the predetermined probability on the basis of a difference between the rarity of the first game medium and the rarity of the second game medium.

11. The game program according to claim 10,
wherein the predetermined probability realizes a function of increasing a winning probability of setting the rarity of the third game medium to be higher than the rarity of the first game medium as the rarity of the second game medium becomes higher than the rarity of the first game medium.

12. The game program according to claim 3,
wherein the privilege increases a predetermined parameter of the third game medium.

13. The game program according to claim 1,
wherein the generation function realizes a function of preventing the second game medium used once for the generation of the third game medium from being used again for the generation of the third game medium.

14. The game program according to claim 1,
wherein the first game medium and the second game medium are maintained in a state before the generation of the third game medium, even after the third game medium is generated.

15. The game program according to claim 1,
wherein the generation function realizes a function of using one second game medium, which is randomly selected, for the generation of the third game medium, in a case where a plurality of the second game mediums are present.

16. The game program according to claim 1,
wherein the generation function realizes a function of generating the third game medium by using one first game medium selected by the user among a plurality of the first game mediums possessed by the user.

17. A portable game terminal device which is capable of wirelessly communicating with another game terminal device positioned in a communicable range and realizes a function of controlling progress of a video game using a first game medium possessed by a user, the game terminal device comprising:
a receptionist configured to receive information regarding a second game medium from the another game terminal device through wireless communication; and
a generator configured to generate a third game medium based on the first game medium and the second game medium in accordance with establishment of a generation condition.

18. A game progress control method of causing a portable computer capable of wirelessly communicating with another computer positioned in a communicable range to control progress of a video game by using a first game medium possessed by a user, the game progress control method comprising:
a reception process of receiving information regarding a second game medium from the another computer through wireless communication; and
a generation process of generating a third game medium based on the first game medium and the second game medium in accordance with establishment of a generation condition.
